(19) United States
(12) Patent Application Publication
(10) Pub. No.: US 2007/0136587 A1
(43) Pub. Date: Jun. 14, 2007

(54) Method for device authentication

(75) Inventors: William M. Shvodian, McLean, VA (US); Rajesh P. Gopi, Herndon, VA (US)

Correspondence Address: POSZ LAW GROUP, PLC, 12040 SOUTH LAKES DRIVE, SUITE 101, RESTON, VA, 20191, US

(73) Assignee: FREESCALE SEMICONDUCTOR, Inc.

(21) Appl. No.: 11/296,502

(22) Filed: Dec. 8, 2005

(51) Int. Cl. H04L 9/00

(52) U.S. Cl. 713/169

(57) ABSTRACT

An authentication method (300) is provided for a local device (120), comprising: receiving a remote encryption key from a remote device (210); performing an authentication process on the remote encryption key (320, 225, 230, 235, 240); receiving a set of secret information at the local device through a local data entry element (350); encoding an authentication message with the remote encryption key (355), the authentication message including the secret information, and the authentication message being signed with a local encryption key; and sending the authentication message to the remote device (355).

### FIELD OF THE INVENTION

The present invention relates in general to a method for authenticating communication between two devices in a wireless network, and in particular, authenticating public keys sent between devices in a wireless network

### BACKGROUND OF THE INVENTION

In most wireless networks, security is an ongoing concern. Because of the nature of a wireless transmission medium, wireless networks are inherently imprecise with respect to the source of any given transmission. As a result, it is often possible in such a network that an interfering device will interpose itself (figuratively or literally) between two communicating devices in order to undermine transmissions between the two. The interfering device could then either intercept data that a communicating device does not want to share with the interfering device, or potentially pass its own transmissions as if they came from one of the communicating devices.

One way to address this problem is through the use of encrypted transmissions. If two devices encrypt their transmissions, then an interfering device cannot easily intercept data or pass fraudulent data. To accomplish this, interfering device would first have to obtain the proper transmission keys before it could interfere with the encrypted communications.

However, the use of encrypted transmissions leads to another potential vulnerability. In order for two communicating devices to pass encrypted transmissions, they must first exchange some sort of encryption/decryption key. In some cases the encryption/decryption keys can be programmed into the devices before operation. In other cases the encryption/decryption keys can be passed between devices during operation, e.g., as the devices first start communicating with each other.

Unfortunately, absent secure communication, this transfer of keys can itself open the communications link to the possibility of interference. For example, without a secure way to pass encryption/decryption keys, an interfering device might be able to intercept the proper encryption/decryption keys, and be able to send or receive encrypted messages.

Some systems use a public-private key system to minimize this danger. In a public-private key system, each device has a public key that it shares with everyone, and a private key that it keeps secret. Any device can use the public key to encode a message. But once encoded with the public key, only the device with the private key can decode the message. Thus, even if an interfering device obtained all of the public keys used by communicating devices, it still could not decrypt any of the messages passing between the devices.

Nevertheless, some danger still remains. If the interfering device were able to interpose itself between two communicating devices when the public keys were first being transferred, it might be able to effectively take the place of a first communicating device by sending its own public key to a second device in place of the one sent by the first device. In this way, the second device might be fooled into thinking that the interfering device was actually the first device. The second device would then send data to and accept data from the interfering device without concern. Potentially this could even happen if the first and second devices were next to each other and the third device was remote, if the third device were powerful enough to drown out the signals from the first and second devices.

Therefore, it is desirable to provide some method of authenticating that a received encryption or decryption key is actually from a specific remote device.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram of a wireless network including two devices according to disclosed embodiments of the present invention;

FIG. 2 is a flow chart of a device authentication method according to a first disclosed embodiment of the present invention;

FIG. 3 is a flow chart of a device authentication method according to a second disclosed embodiment of the present invention;

FIG. 4 is a block diagram of a wireless network including three devices according to disclosed embodiments of the present invention;

FIG. 5 is a flow chart of a device authentication method according to a third disclosed embodiment of the present invention; and

FIG. 6 is a flow chart of a device authentication method according to a fourth disclosed embodiment of the present invention.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

The circuits and methods described below are applicable to any wired or wireless interface module that has different output power requirements. One particular type of interface module in which the methods and circuits are particularly applicable is ultrawide bandwidth (UWB) interface module. However, they should not be limited to UWB interface modules.

Also, although described below with respect to the authentication of public keys being passed between devices, this is by way of example only. The methods described below can be used to authenticate other types of security information being passed between devices.

Basic Wireless Network

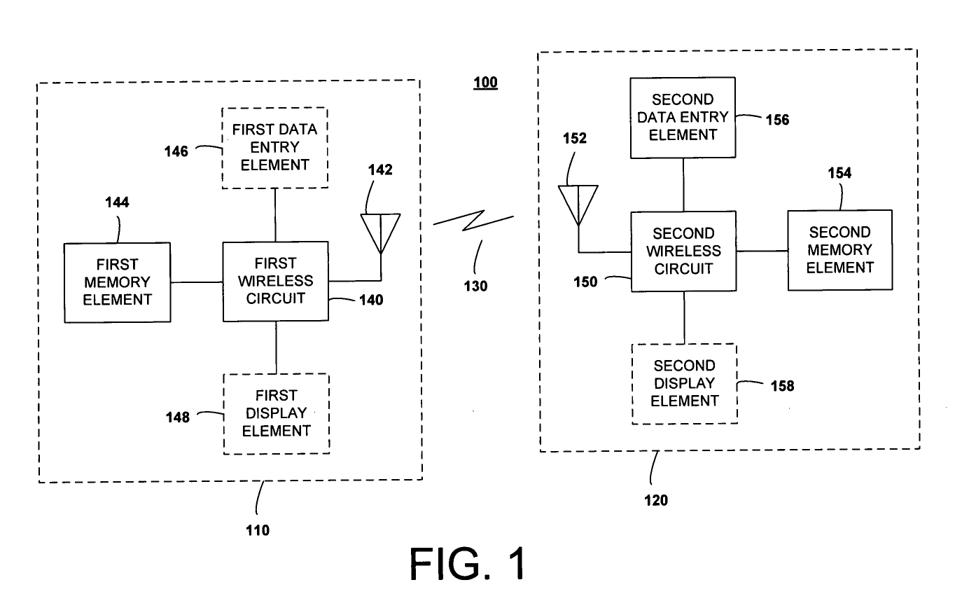

FIG. 1 is a block diagram of a wireless network including two devices according to disclosed embodiments of the present invention. This can be used for many authentication methods that are done between two devices without outside equipment.

As shown in FIG. 1, the network includes a first device 110 and a second device 120 that communicate via wireless signals 130. The first device 110 includes a first wireless element 140, a first antenna 142, and a first memory element 144, and may include a first data entry element 146 and a first display element 148. The second device 120 includes a second wireless element 150, a second antenna 152, and a second memory element 154, and may include a second data entry element 156 and a second display element 158.

The first wireless element 140 represents the circuitry needed to generate and receive the wireless signals 130, as well as any interface circuitry to allow the first wireless element 140 to communicate with a host device (e.g., cell phone, computer, camera, PDA, etc.). The circuitry needed to generate and receive the wireless signals 130 may include a radio frequency (RF) portion, a baseband portion, and a MAC portion working together to enable wireless communication.

The first wireless element 140 also includes circuits and software to enable encryption and decryption. These encryption/decryption elements can include a symmetric encryption mechanism (e.g., AES-CCM) or a public-private key encryption mechanism, or both.

The first antenna 142 is connected to the first wireless element 140 and is used to transmit and receive the wireless signals 130. It can be any antenna appropriate to the first wireless element 140.

The first memory element 144 can be used to store authentication information. It should have at least a volatile memory portion for storing authentication information relating to a device in a current data transmission. It may also have a non-volatile memory portion for storing authentication information relating to devices in past data transmissions.

The first data entry element 146 is provided to allow a user to provide information to the first wireless element 140. In some embodiments the first data entry element 146 is a device that allows complex data to be entered, e.g., a keyboard or a number pad. In other embodiments the first data entry element 146 can be as simple as one or two buttons or a dial. Alternate embodiments can use any suitable device for entering data.

The first display element 148 is provided to display information to a user. In the disclosed embodiments this is a visual display. However, alternate embodiments could use alternate display types, e.g., an audio display. In some embodiments the first display element 148 could be a liquid crystal display (LCD) or a display of light-emitting diodes (LEDS), thought any suitable device for displaying information can be used.

The second wireless element 150, the second antenna 152, the second memory element 154, the second data entry element 156, and the second display element 158 are comparable to the first wireless element 140, the first antenna 142, the first memory element 144, the first data entry element 146, and the first display element 148 described above, and can be implemented as described above for these elements.

The devices 110 and 120 can be wireless devices of any sort. This includes ultrawide bandwidth devices, WiFi devices, Bluetooth devices, wireless USB devices, or any other wireless communication system that would need to authenticate the identity of devices in the network.

First Authentication Method

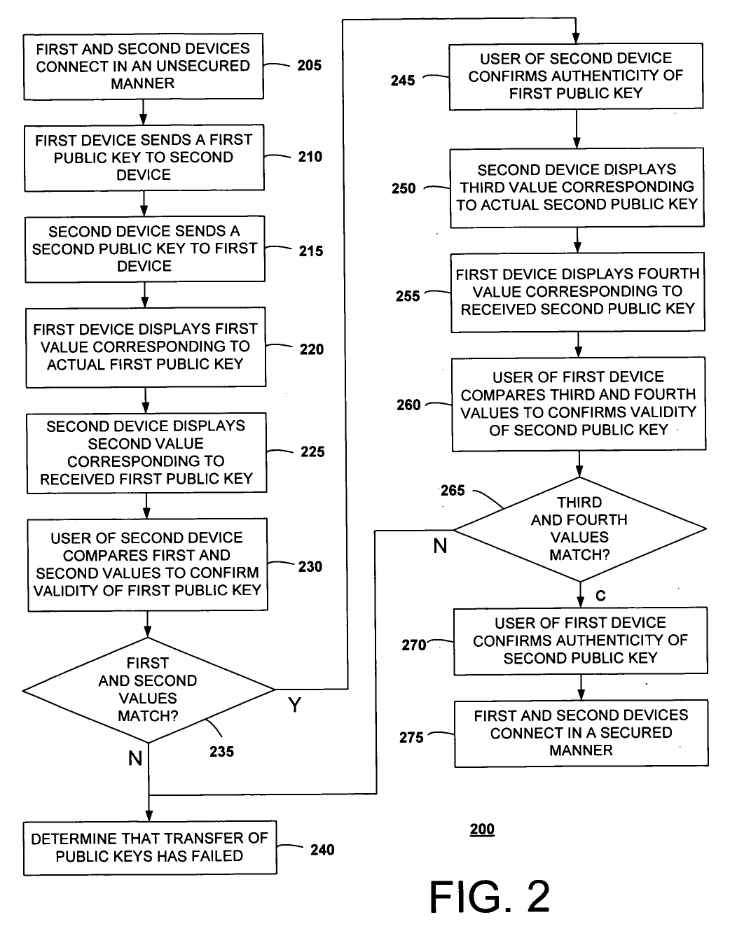

When two wireless devices, such as the first and second devices 110 and 120 of FIG. 1, first contact each other, they can perform an authentication operation to securely pass encryption information to enable later secure communication. FIG. 2 is a flow chart of a device authentication method according to a first disclosed embodiment of the present invention. In this embodiment the first and second device 110 and 120 both include data entry elements 144, 154 and display elements 146, 156.

As shown in FIG. 2, the authentication process 200 begins when the first and second devices 110 and 120 connect in an unsecured manner. (205) One way this may be accomplished by having one of the devices act as a network controller and send out a beacon identifying the network. The other device can then respond to that beacon with an association request and the two devices can perform an association process to establish basic communication. However, alternate processes for connecting in an unsecured manner are possible.

After establishing basic communications, the first device 110 sends a first public key to the second device 120 (210), and the second device 120 sends a second public key to the first device 110 (215). The first and second public key will be sent in the clear, i.e., unencrypted, since the first and second devices 110 and 120 are engaged in unsecured communication. These public keys are part of public-private key pairs, and the first and second devices 110 and 120 will store respective first and second private keys.

The first device 110 will then display a first value on its first display element 148. (220) This first value will correspond to the actual first public key sent by the first device 110. In one embodiment the entire actual first public key could be displayed. In alternate embodiments, however, a number that is derivative of the first public key could be displayed. For example, the first public key could be passed through a hashing function to generate a first value that is smaller than the actual first public key. In another embodiment only a portion of the first public key is displayed. If a derivative first value is used, the display can be smaller, and the user may have an easier time identifying the smaller first value.

The second device 120 will then display a second value on its second display element 158. (225) This second value will correspond to the first public key received by the second device 120. In one embodiment the entire received first public key could be displayed. In alternate embodiments, however, a number that is derivative of the received first public key could be displayed. For example, the received first public key could be passed through a hashing function to generate a second value that is smaller than the received first public key, or a portion of the first public key could be used as a first value. If a derivative second value is used, the display can be smaller, and the user may have an easier time identifying the smaller second value.

Exemplary hashing functions that could be used include a secure hash function (SHA), such as a SHA-1 or SHA-256 hashing function. However, alternate hashing functions could be used.

Regardless of whether the first and second values are the whole public keys values derived from the whole public keys, the same process should be used by the first and second devices 110 and 120 to determine the first and second values. In other words, whatever display process is used by each device should display the same value when the same public key is used.

Regardless of whether the entirety of the public keys are displayed or derivative first and second values are displayed, the same process should be used by the first and second devices. In other words, whatever display process is used should display the same value when the same public keys are used.

Once both the first and second values are displayed on their respective display elements 146, 156 (220, 225), the user of the second device will compare the first and second values to confirm the validity of the first public key (230) and determines if the two values match (235).

The comparison of first and second values to see if they match (230 and 235) can be done in a variety of manners. If the two devices are close to each other, the user of the second device can simply examine both display elements 146, 156. If they are not close to each other, but the user of the second device 120 is in an alternate secure communications link with the user of the first device, then the user of the first device 110 could examine the first value and provide it to the user of the second device 120. This second situation could happen, for example, if the users of the first and second devices are in voice communication, or email communication via secure network.

If the user of the second device 120 determines that the values don't match, this means that the public key received by the second device 120 is not the same key that was sent by the first device 110. The user of the second device will know that some interfering device sent the pubic key that the second device, and the user of the second device can determine that the transfer of public keys has failed. (240) At this point some kind of error processing can take place, the user could try the authentication process again under more secure circumstances, the user could end communication altogether, or the user or the second device 120 could take whatever action was deemed appropriate.

If, however, the user of the second device 120 determines that the first and second values do match, this means that the public key received by the second device 120 is the same key that was sent by the first device 110. The second user then confirms the authenticity of the first public key at the second device. (245) This can be as simple as pressing a key in the second data entry element 156 to indicate acceptance of the first public key, or could involve a more complicated process of entering data into the second data entry element 156.

In order to prevent a user from just selecting “Yes” without actually verifying the validity of the public key, the user could be required to enter one or more of the digits of the key. This will serve to reduce the probability of a user accidentally accepting an invalid key . Alternatively the user of the second device could be asked to enter the hash of the public key as displayed on device one, without ever displaying the hash on device 2.

The second device 120 will then display a third value on its second display element 158. (250) This third value will correspond to the actual second public key sent by the second device 120. As with the first value, the third value could be the entirety of the actual second public key or a value derived from the actual second public key.

The first device 110 will then display a fourth value on its first display element 148. (255) This fourth value will correspond to the second public key received by the first device 110. As with the second value, the fourth value could be the entirely of the received second public key or could be a value derived from the second public key.

In addition, regardless of whether the third and fourth values are the whole public keys values derived from the whole public keys, the same process should be used by the first and second devices 110 and 120 to determine the third and fourth values. In other words, whatever display process is used by each device should display the same value when the same public key is used.

Once both the third and fourth values are displayed on their respective display elements 146, 156 (250, 255), the user of the first device 110 will compare the third and fourth values to confirm the validity of the first public key (260) and determines if the two values match (265).

The comparison of third and fourth values to see if they match (260 and 265) can be done in a variety of manners as described above with respect to the comparison of first and second values (230 and 235). In fact, these two comparison processes could be done at the same time in some embodiments.

If the user of the first device 110 determines that the values don't match, this means that the public key received by the first device 110 is not the same key that was sent by the second device 120. The user of the first device 110 will know that some interfering device sent the pubic key, and the user of the second device can determine that the transfer of public keys has failed. (240) As noted above, the user or device can then take appropriate action.

If, however, the user of the first device 110 determines that the third and fourth values do match, this means that the public key received by the first device 110 is the same key that was sent by the second device 120. The first user then confirms the authenticity of the second public key at the first device 110. (270) As noted above, this can be as simple as pressing a key in the first data entry element 146 to indicate acceptance of the first public key, or could involve a more complicated process of entering data into the first data entry element 146.

At this point, the first device 110 has successfully received the second public key from the second device 120, and the second device 120 has successfully received the first public key from the first device 110. The two can now connect in a secure manner using the first and second public keys for encryption.

The devices 110 and 120 can then proceed using the first and second public keys for encryption, or they can use the first and second public keys to securely exchange symmetrical encryption keys. One way to accomplish this would be to have one device send a symmetric key that is encoded with the destination device's public key and signed by the source device's public key.

In some alternate embodiments, the authenticated public and private keys can be stored in non-volatile portions of first and second memory elements 148 and 158. This allows the devices 110 and 120 to avoid the need for an authentication process if after the passage of time they again enter into communication with each other.

This would allow the devices 110, 120 to employ a challenge sequence using authenticated public keys to set up a secure data stream at a later time, rather than a new authentication process. Thus, a new secure data stream can be started without requiring additional action by the users. This can be particularly advantageous if the users are no longer close to each other or no longer have access to another secure communications network.

Second Authentication Method

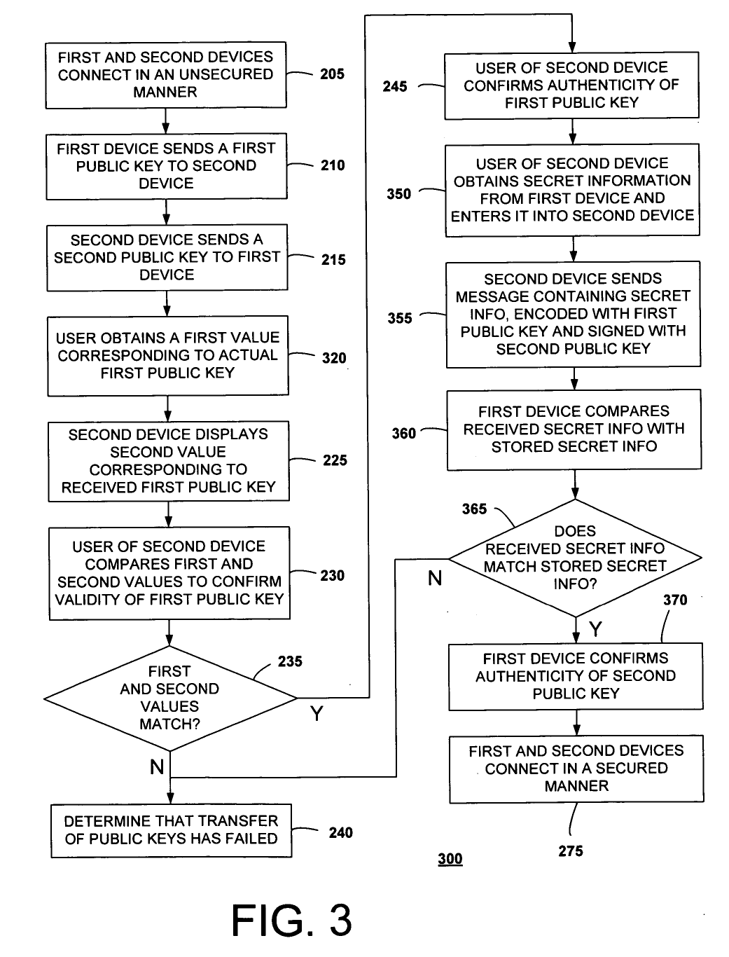

Some devices do not have all of the features shown in FIG. 1, however. For example a wireless headset might only have single button as a data entry element and no display element. FIG. 3 is a flow chart of a device authentication method according to a second disclosed embodiment of the present invention. This embodiment will operate when a first device 110 does not have one or both of a first data entry element 146 or a first display element 148, but a second device has both a second data entry element 156 and a second display element 158.

As shown in FIG. 3, the authentication process 300 begins when the first and second devices 110 and 120 connect in an unsecured manner (205), and the devices 110 and 120 exchange public keys (210, 215), as shown above with respect to FIG. 2.

However, since the first device 110 has no first display element 148, it can't display a first value that corresponds to the actual first public key that it transmitted. But, the first value can be recorded in a more permanent form and obtained in another manner by the user of the second device 120. (320) For example, the first value could be printed on casing of the first device 110, printed on the inside of a battery panel in the first device 110, printed on a piece of paper that is provided with the first device 110, etc. If the second user is close to the first device 110, he can simply read the first value from where it's stored. If the second user is distant from the first device 110 but in secure communication with the first user (e.g., voice communication, secure internet communication, etc.), the first user can pass the first value on to the second user.

The reason that this can work is that the first value remains constant so long as the first public key remains constant. If the first device 110 maintains the same first public key, it likewise will maintain the same first value. And even if the first device 110 occasionally changes its public-private key pair, the new public key will be known and so a first value corresponding to that new public key can be determined and maintained proximate to the first device 110.

The second device 120 then displays the second value based on the received first public key (225); the second user compares the first and second values (230) to determines whether they match (235); and the second user or the second device either determines that the transfer of public keys has failed (240), or the second user confirms the authenticity of the public key (245), as described above with respect to FIG. 2.

However, since the first device 110 does not have a first display element 148, this process must use a different mechanism to confirm the second public key. Even though the second device 120 could display a third value corresponding to the actual second public key, the first device could not display a fourth value corresponding to a received second public key.

Instead, the user of the second device 120 obtains some secret information from the first device 110 and enters it into the second device 120 through the second data entry element 156. (350) This secret information can be a bit sequence, a numeric sequence, an alphanumeric sequence, or the like, depending upon the nature of the second data entry element 156. The secret information should not be derivative of either the first or second public keys so that it cannot be easily predicted by an interfering device that intercepted the first or second public keys.

In some embodiments as the secret information is being entered in, it will be displayed on the second display element 158 to allow the second user to confirm that it is being entered in correctly.

As with the first value, the secret information can be stored on or near the first device. For example, the secret information could be printed on casing of the first device 110, printed on the inside of a battery access panel in the first device 110, printed on a piece of paper that is provided with the first device 110, etc. In fact, the secret information and the first value could be printed next to each other for ease of use during the authentication process.

The second user could obtain this secret information by either reading it off of the first device (or wherever it is stored), or by receiving it from the first user over a different secure data link (e.g., a telephone link, secure internet link, etc.). This adds no significant burden on authentication. Since the user of the second device already needed access to the confirmation information to authenticate the first public key, he can obtain the secret information at the same time that it obtains the first confirmation information.

Once the secret information has been entered into the second device 120, the second device 120 sends an authentication message to the first device containing the secret information. (355) This authentication message is encrypted using the first public key and is signed with the second public key.

The first device 110 receives the authentication message, extracts the secret information, and compares the received secret information with the actual secret information (360) stored in the first memory element 144 of the first device 110 to determine whether the received secret information matches the stored secret information (365). In various embodiments the secret information can be stored in the first device in a first memory element 148, hardwired into the first wireless circuit 140, or in any manner deemed suitable.

In some embodiments the first device 110 can also check to make certain that the secret information was sent by the second device 120 by checking the signature of the authentication message.

In some embodiments, rather than sending the secret, a derivative of the secret is sent. For instance the first device could send a random number to the other device, The second device then has to perform an operation on the random number and the secret, then return the value. In that way, the shared secret is never actually transmitted and so its value cannot be intercepted.

If the first device 110 determines that the received secret information does not match the stored secret information (365), then it will determine that the transfer of public keys has failed (240) and take appropriate action.

If, however, the first device 110 determines that the received secret information does match the stored secret information (365), then it will confirm the authenticity of the second public key (370), and the first and second devices 110 and 120 can connect in a secured manner, as described above with respect to FIG. 2.

Because the first value and the secret information either do not change, or change very infrequently, they can be printed on or near the first device 110 and used by the second device 120 as described above. In this way an authentication process can be performed even when the first device 110 doesn't have one or both of a first data entry element 146 or a first display element 148.

An interfering device would not have access to the secret information. So even if the interfering device were able to spoof the first device 110 into thinking it were the second device 120, it would not be able to supply the secret information and so the first device would not authenticate its public key.

Using this method, the larger the number of possible secrets, the more secure the authentication method is. For example, if every device had a unique set of secret information, it would be very difficult for an interfering device to predict the actual secret information used by a given device. Contrarily, if every device had the same sort of secret information, it would be comparatively easy for an interfering device to predict the secret information.

In alternate embodiments, the devices 110 and 120 can keep track of how many attempts are made to try and authenticate, and trigger some kind of error message or failure if too many attempts are made unsuccessfully. In thus way, even if an interfering user had a list of valid secrets used by different devices, it would not be able to just run through all of them in an effort to come upon the correct secret. In the alternative, the devices could limit how often an attempt could be made (e.g., once every ten seconds or the like).

As noted above with respect to the embodiment of FIG. 2, in some alternate embodiments, the authenticated public and private keys can be stored in non-volatile portions of first and second memory elements 148 and 158. This allows the devices 110 and 120 to avoid the need for an authentication process if after the passage of time they again enter into communication with each other.

Expanded Wireless Network

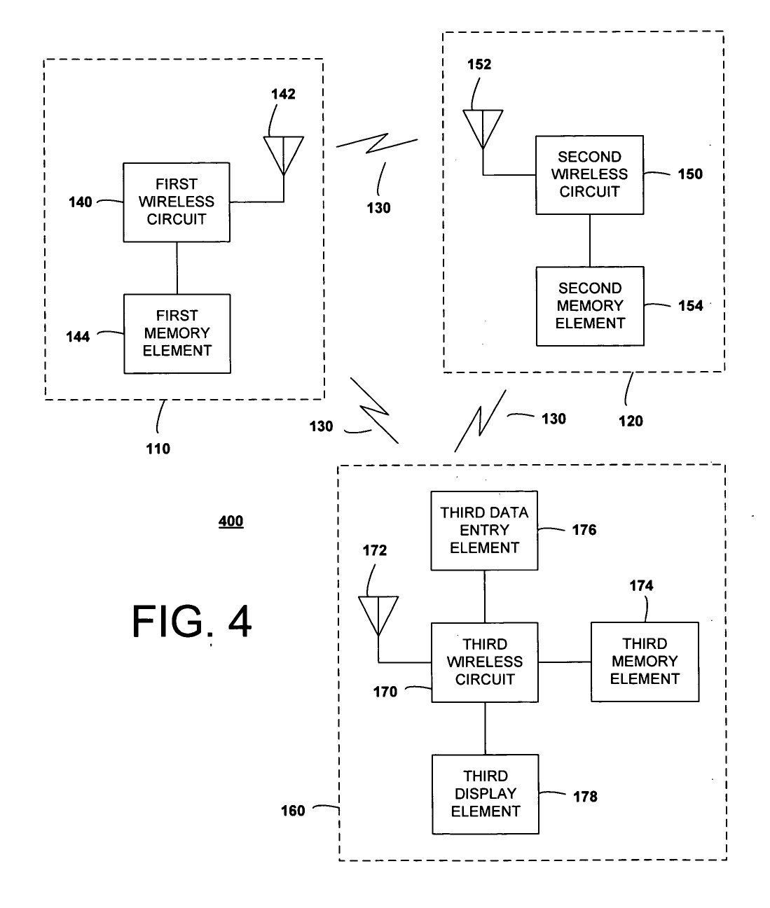

In some situations it may be desirable to authenticate public keys for two devices that each doesn't have one or both of a data entry element or a display element, e.g., two dongles that might want to link up whenever they get close enough to each other for communication. In this case a third device can be used as an intermediate. FIG. 4 is a block diagram of a wireless network including three devices according to disclosed embodiments of the present invention.

As shown in FIG. 4, the network 400 includes a first device 110, a second device 120, and a third device 160 that communicate via wireless signals 130. The first device 110 includes a first wireless element 140, a first antenna 142, and a first memory element 144. The second device 120 includes a second wireless element 150, a second antenna 152, and a second memory element 154. And the third device 160 includes a third wireless element 170, a third antenna 172, a third memory element 174, as third data entry element 176, and a third display element 178.

The elements in the first and second devices 110 and 120 are as described above with respect to FIG. 1. The third wireless element 170, the third antenna 172, the third memory element 174, the third data entry element 176, and the third display element 178 are comparable to the first wireless element 140, the first antenna 142, the first memory element 144, the first data entry element 146, and the first display element 148 described above, and can be implemented as described above for these elements.

Third Authentication Method

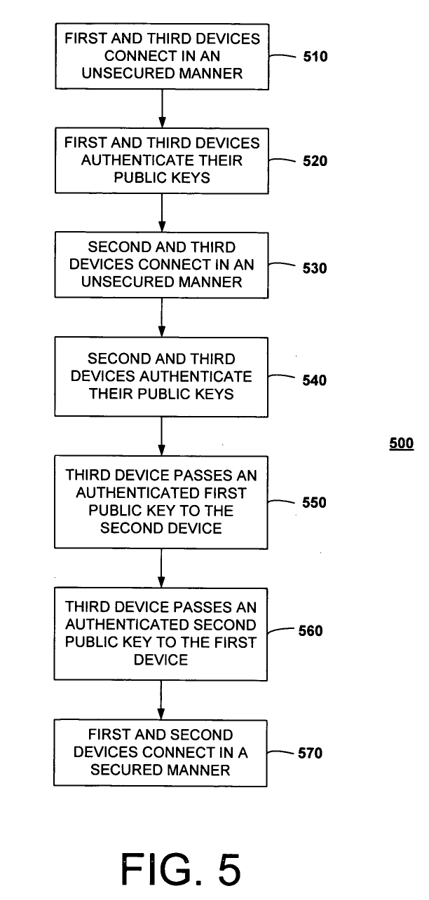

In the system described shown in FIG. 4, the third device 160 can serve as an intermediate, authenticating the first and second public keys individually, and then passing on these authenticated public keys through its own secure communications between itself and the first and second devices 110 and 120. FIG. 5 is a flow chart of a device authentication method according to a third disclosed embodiment of the present invention.

As shown in FIG. 5, the authentication process 500 begins by having the first and third devices 110 and 160 connect with each other in an unsecured manner. (510) This is comparable to the unsecured connection (205) described above with respect to FIG. 2.

After the first and third devices 110 and 160 have initiated communication (510) they perform an authentication process between them so that they can authenticate first and third public keys. (520) This can be done in any acceptable manner, including, by way of example, the authentication processes 200, 300, and 600 described in this specification. At the end of this authentication process (520), the first device 110 will have authenticated the third public key, and the third device 160 will have authenticated the first public key.

The second and third devices 120 and 160 connect with each other in an unsecured manner. (530) This is comparable to the unsecured connection (205) described above with respect to FIG. 2.

After the second and third devices 120 and 160 have initiated communication (530) they perform an authentication process between them so that they can authenticate second and third public keys. (540) This can be done in any acceptable manner, including, by way of example, the authentication processes 200, 300, and 600 described in this specification. At the end of this authentication process (540), the second 120 device will have authenticated the third public key, and the third device 160 will have authenticated the second public key.

At this point in time, the first and second devices 110 and 120 have each only authenticated the third public key, while the third device 160 has authenticated both the first and second public keys. This means that the first and third devices 110 and 160 can engage in secure communication, and the second and third devices 120 and 160 can engage in secure communication.

This further allows the third device 160 to securely connect with the second device 120 and pass the authenticated first public key to the second device 120 (550), and to securely connect with the first device 110 and pass the authenticated second public key to the first device 110 (560) The first device 110 can trust the authenticity of the second public key since it trusts the third device 160, which trusts the second device 120. Similarly, the second device 120 can trust the authenticity of the first public key since it trusts the third device 160, which trusts the first device 110.

Having obtained the proper public keys and having ensured that they are authentic, the first and second devices 110 and 120 can then connect in a secure manner. One way to establish secure communications between the first and second device, is for them to challenge each other to decrypt a message that was encrypted with the public key that they have stored as a trusted key. Only a device with the private key that corresponds to the trusted public key can successfully decrypt the message encrypted with the public key. (570) This is comparable to the secure connection (275) described above with respect to FIG. 2. Furthermore, once the first and second devices 110 and 120 have begun secure communication, they no longer need to be in range of the third device 160. Thus, the first and second devices 110 and 1120 could be brought into range of the third device 160 for the purposes of authentication, but then moved to another area for operation (e.g., bringing mobile devices into range of a desktop computer for authentication). Alternately, the third device 160 could be sequentially brought into range of the first and second devices 110 and 120 for authentication (e.g., bringing a cell phone or PDA into range of remote devices to authenticate them).

Furthermore, although this authentication process 500 is shown as being applied to first and second devices 110 and 120 that have no data entry elements 144, 154 or display elements 146, 156, it could be used on devices that have these features. In some embodiments it may be desirable to have a third device 160 operate as an authentication proxy for other reasons. For example, the third device 160 might be centrally located, easier to access or operate, etc.

As noted above with respect to the embodiment of FIG. 2, in some alternate embodiments, the authenticated public and private keys can be stored in non-volatile portions of first and second memory elements 148 and 158. This allows the devices 110 and 120 to avoid the need for an authentication process if after the passage of time they again enter into communication with each other.

Fourth Authentication Method

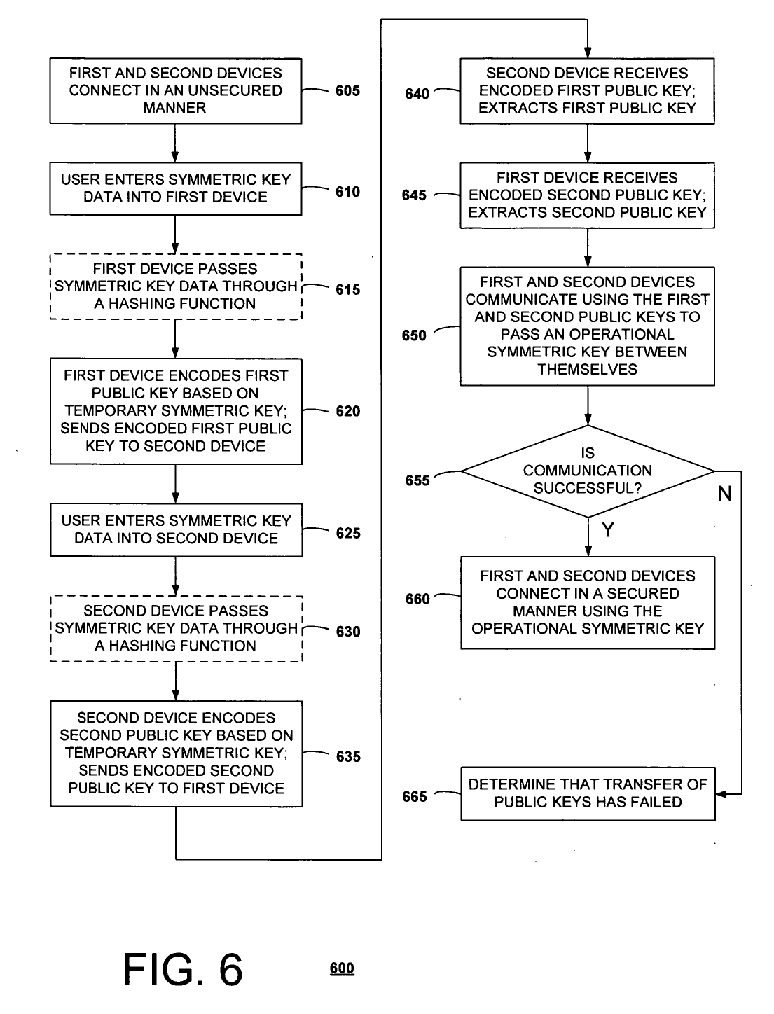

In some embodiments it may also be desirable to authenticate devices that have very limited data entry elements or display elements. FIG. 6 is a flow chart of a device authentication method according to a fourth disclosed embodiment of the present invention.

As shown in FIG. 6, the authentication process 600 begins when first and second devices 110 and 120 connect with each other in an unsecured manner. (605) This is comparable to the unsecured connection (205) described above with respect to FIG. 2.

A user then enters symmetric key data into the first device 110 using the first data entry element 146. (610) The exact nature of the symmetric key data can vary depending upon the nature of the first data entry element 146. For example, in one embodiment the first data entry element 146 might be two buttons, making it capable of entering in bit values. In this case, the symmetric key data could be a series of bit values. In another embodiment if the first data entry element 146 were a number pad, the symmetric key data could be a numeric sequence. In yet another embodiment if the first data entry element 146 were a keyboard, the symmetric key data could be an alphanumeric sequence. If the first device 110 has a first display element 148, it may display the symmetric key data as its being entered to allow the user to confirm its accuracy.

The symmetric key data may be set beforehand or it may be generated spontaneously by the user. In the latter case, it will be very difficult for an interfering device to predict the symmetric key data, since it is generated on the spot by the user.

In one embodiment the symmetric key, as entered into the first device 110, is used directly as a temporary symmetric key. In a second embodiment the symmetric key data, as entered into the first device 110, is first passed through a known hashing function (615) to generate a temporary symmetrical key used to encode the first public key. In some alternate embodiments, the symmetric key data is used to encrypt a final symmetric key to be used for communications.

Regardless of how it obtains the temporary symmetric key, the first device 110 then encodes a first public key based on the temporary symmetric key and sends the encoded first public key to the second device. (620) In this embodiment the encoding is a symmetrical encoding, meaning that the same temporary symmetric key that was used to encode the message containing first public key can also be used to decrypt the message containing the first public key. Exemplary encryption techniques are AES, RC4, 3DES encryption or 3DES encryption, though other symmetrical encryption techniques can also be used.

A user then enters the symmetric key data into the second device 120 using the second data entry element 156. (625) This should be the same symmetric key data that was entered into the first device 110, so that the first and second devices 110 and 120 are coordinated with their encrypting and decrypting. If the second device 120 has a second display element 158, it may display the symmetric key data as its being entered to allow the user to confirm its accuracy.

As with the operation of the first device 110, in one embodiment the symmetric key data, as entered into the second device 120, is used directly as a temporary symmetric key. In a second embodiment the symmetric key data, as entered into the second device 120, is first passed through a known hashing function (630) to generate a temporary symmetrical key used to encode the second public key. In some alternate embodiments, the symmetric key data is used to encrypt a final symmetric key to be used for communications. Regardless of how this is done, the same process should be applied at both the first and second devices 110 and 120 so that the encryption/decryption processes at these devices will be coordinated.

The second device 120 then encodes a second public key based on the symmetric key and sends the encoded second public key to the first device 110. (635)

The second device 120 receives the message including the encoded first public key and extracts the first public key from it. (640) Similarly, the first device 110 receives the message including the encoded second public key and extracts the second public key from it. (645) Since each message was encoded using the same symmetrical encryption key, a key which both devices 110 and 120 have, the messages can be easily decrypted. However, an interfering device would not have access to the symmetric key and so could not easily decrypt the messages, nor could it easily encrypt fraudulent messages that would be accepted at either device 110 or 120.

In this way, the first and second public keys can be exchanged in a secure manner. Each will be authenticated by the temporary symmetric key. As a result, a man-in-the-middle interfering device could not intercept messages between the first and second devices 110 and 120 and insert its own public keys. Without the temporary symmetric key, the interfering device would be unable to decrypt or encrypt the necessary public keys. And although it is possible that an interfering device could process the messages passed between the first and second devices 110 and 120 to recover the temporary symmetric key, the device would be unlikely to be able to complete such a process within the time necessary for the two devices to set up a secure communication link.

After the first and second devices 110 and 120 have securely exchanged their public keys, the devices can engage in a process of passing an operational symmetric key between themselves for general communication using the public keys for encryption. (650) The operational symmetric key can be generated and shared using any appropriate way known in the art. One way of implementing this would be to have one of the devices generate the operational symmetric key as a random multiple-bit number (e.g. 1024-bit), break it up into multiple portions and send these portions to the other device in a negotiated fashion (e.g., using a Diffie-Helmen algorithm). However, other methods of generating and securely passing an operational symmetric key can be used. Regardless, since the public keys were authenticated using the temporary symmetric key, this communication is also secure.

If the communication of the operational symmetric key is successful (655), then the two devices 110 and 120 can proceed to connect in a secured manner using the operational symmetric key for data transfer. (660)

If, however, the communication is not successful, then this means that the transfer of symmetric keys between the first and second device was not successful. This may be the result of another device trying to insert itself between the two, or some other security breach. One way this could occur is if a device intercepted one or both of the messages including the first and second public keys and tried to pass its own messages in their place. When these fraudulent messages were decrypted, they would generate incorrect first and second public keys. And when these incorrect public keys were used to try and pass the operational symmetric key, the respective devices would be unable to decrypt the data signals and communication would fail.

In the case of a communication failure like this, the devices 110 and 120 would determine that the transfer of public keys was a failure, and take appropriate action. (665)

As noted above with respect to the embodiment of FIG. 2, in some alternate embodiments, the authenticated public and private keys can be stored in non-volatile portions of first and second memory elements 148 and 158. This allows the devices 110 and 120 to avoid the need for an authentication process if after the passage of time they again enter into communication with each other.

Conclusion

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. An authentication method for a local device, comprising:
receiving a remote encryption key from a remote device;
performing an authentication process on the remote encryption key;
receiving a set of secret information at the local device through a local data entry element;
encoding an authentication message with the remote encryption key, the authentication message including the secret information, and the authentication message being signed with a local encryption key; and
sending the authentication message to the remote device.

2. An authentication method for a local device, as recited in claim 1, further comprising: storing the remote encryption key in a memory element in the local device after performing the authentication process.

3. An authentication method for a local device, as recited in claim 1, wherein performing of the authentication process comprises receiving a confirmation indicator through the local data entry element.

4. An authentication method for a local device, as recited in claim 1, wherein the remote encryption key is a remote public key from a remote public-private key pair, and

5. An authentication method for a local device, as recited in claim 1, further comprising: sending the local encryption key to the remote device prior to sending the authentication message.

6. An authentication method for a local device, as recited in claim 1, wherein the data entry element is one of a keyboard, a number pad, a push button, a touchscreen, a tablet entry, a dial, or a dipswitch.

7. An authentication method for a local device, as recited in claim 1, wherein the set of secret information is one of: a plurality of bit values, a plurality of numeric values, a plurality of alphanumeric values, and a mathematical operation on one of the plurality of bit values, the plurality of numeric values, or the plurality of alphanumeric values.

8. An authentication method for a local device, as recited in claim 1, wherein the secret information is not derivative of either the local encryption key or the remote encryption key.

9. An authentication method for a local device, comprising:
sending a local encryption key to a first remote device;
receiving a first remote encryption key from the first remote device;
performing a first authentication process with the first remote device to authenticate the first remote encryption key;
sending the local encryption key to a second remote device;
receiving a second remote encryption key from the second remote device;
performing a second authentication process with the second remote device to authenticate the second remote encryption key;
sending the authenticated first remote encryption key to the second remote device after performing the second authentication process; and
sending the authenticated second remote encryption key to the first remote device after performing the first authentication process.

10. An authentication method for a local device, as recited in claim 9, wherein the sending of the authenticated first remote encryption key to the second remote device further comprises:
encoding a first local authentication message including the first remote encryption key, the first local authentication message being encoded based on the second remote encryption key; and
sending the first local authentication message to the second remote device.

11. An authentication method for a local device, as recited in claim 10, wherein the sending of the authenticated second remote encryption key to the first remote device further comprises: encoding a second local authentication message including the second remote encryption key, the second local authentication message being encoded based on the first remote encryption key; and
sending the second local authentication message to the first remote device.

12. An authentication method for a local device, as recited in claim 10, wherein the performing of the first authentication process further comprises:
displaying a first authentication value on a local display element on the local device, the first authentication value corresponding to the first remote encryption key;
receiving a first confirmation signal from a local data entry element on the local device, the first confirmation signal confirming that the displayed first authentication value is correct; and
authenticating the first remote encryption key after receiving the first confirmation signal.

13. An authentication method for a local device, as recited in claim 12, wherein the first authentication value is determined by running the first remote encryption value through a first hashing function.

14. An authentication method for a local device, as recited in claim 12, wherein the performing of the second authentication process further comprises:
displaying a second authentication value on the local display element, the second authentication value corresponding to the second remote encryption key;
receiving a second confirmation signal from the local data entry element, the second confirmation signal confirming that the displayed second authentication value is correct; and
authenticating the second remote encryption key after receiving the second confirmation signal.

15. An authentication method for a local device, as recited in claim 14, wherein the second authentication value is determined by running the second remote encryption value through a second hashing function.

16. An authentication method for a local device, comprising:
receiving a temporary symmetric key at the local device through a local data entry element;
encoding a local authentication message including a local encryption key, the local authentication message being encoded based on the temporary symmetric key;
sending the local authentication message to a remote device;
receiving a remote authentication message from the remote device;
decoding the remote authentication message to extract a remote encryption key, the remote authentication message being decoded based on the temporary symmetric key;
receiving a remote key transfer message from the remote device;
decoding the remote key transfer message to extract a remote key transfer payload, the remote key transfer message being encoded with the local encryption key; and
authenticating the remote encryption key if the remote key transfer payload is successfully received.

17. An authentication method for a local device, as recited in claim 16, further comprising:
encoding a local key transfer message including a local key transfer payload, the local key transfer message being encoded with the remote encryption key;
sending the local key transfer message to the remote device;

18. An authentication method for a local device, as recited in claim 16, wherein the data entry element comprises one or more buttons.

19. An authentication method for a local device, as recited in claim 16, wherein the temporary symmetric key comprises one of: a plurality of bit values, a plurality of numeric values, and a plurality of alphanumeric values.

20. An authentication method for a local device, as recited in claim 16, further comprising: storing the remote encryption key in a memory element in the local device after authenticating the remote encryption key.
